(19) United States
(12) Patent Application Publication
(10) Pub. No.: US 2010/0025347 A1
(43) Pub. Date: Feb. 4, 2010

(54) Plant tray for biodegradable pots

(76) Inventor: Jack Van de Wetering, Calverton, NY (US)

Correspondence Address: Thomas A. O'Rourke;Bodner & O'Rourke, L.L.P., Ste. 108, 425 Broadhollow Road, Melville, NY, 11747, US

(21) Appl. No.: 12/460,583

(22) Filed: Jul. 21, 2009

Related U.S. Application Data
(63) Continuation-in-part of application No. 11/646,187, filed on Dec. 27, 2006.
Application No. 11/646,187 is a continuation-in-part of application No. 11/716,524, filed on Mar. 9, 2007.
(60) Provisional application No. 61/135,571, filed on Jul. 22, 2008.

(51) Int. Cl. A47F 7/00; A01G 9/02

(52) U.S. Cl. 211/71.01; 47/74

(57) ABSTRACT

A system for transporting a biodegradable planter is described. There is a tray for carrying a biodegradable planter. This tray includes one or more biodegradable members which form an orifice for receiving a biodegradable planter. The biodegradable planter has a least one side wall and a base. The sidewall forms a receptacle for receiving a plant growing medium.

This application claims priority on U.S. Provisional Application Ser. No. 61/135,571 filed Jul. 22, 2008 the disclosures of which are incorporated herein by reference. This is a continuation-in-part of U.S. application Ser. No. 11/646,187 filed Dec. 27, 2006 and Ser. No. 11/716,524 filed Mar. 9, 2007 the disclosures of which are incorporated herein by reference.

### FIELD OF THE INVENTION

The present invention relates to improvements in transporting plants packaged in biodegradable pots that may be planted in the ground along with the seedling. More specifically, the present invention is directed to trays for thin walled biodegradable planters made from straw and/or coir. More particularly the invention is directed to a planter and a tray for carrying one or more planters.

### BACKGROUND OF THE INVENTION

In U.S. application Ser. No. 11/716,524 and U.S. application Ser. No. 11/646,187 filed Mar. 9, 2007 there are disclosed certain improved biodegradable planters. These planters are made from a unique blend of straw and/or coir and are coated on at least one surface with a latex material. These planters have superior biodegradeability. In particular, the planters of the above application biodegrade in short periods of time and therefore are particularly suited for planting small seedlings and plants directly into the soil so that the pot biodegrades within a couple of months or so of planting. This is a significant improvement over traditional pots which require significantly greater periods of time to biodegrade. In fact, many of these planters take a year or more to biodegrade in the soil. The disclosure of U.S. application Ser. No. 11/646,187 filed Dec. 27, 2006 and Ser. No. 11/716,524 filed Mar. 9, 2007 are incorporated herein by reference.

The pots of the copending applications are made from straw or coir and blends thereof and are provided with a thin layer of latex on at least one side of the pot to provide the pot with structural integrity as the plant is handled during shipment and at the homeowner's residence prior to planting in the ground. The coir and straw are fairly thin materials and the sidewalls of the pots can be delicate particularly when the individual pots are shipped in stacks where the bottom of one pot goes into the opening of the next pot. As the pots settle together during shipment it can be difficult, at times, to separate them due to the rough surface of their sidewalls and the small amounts of latex used to hold the straw or coir together in the form of a planter.

Many commercial pots that are used by growers and owners are fairly delicate because of their thin walls and from the moisture present from watering. As a result there is a need to reduce handling of the pots prior to planting. One way nurseries and other growers have avoided the problems with peat pots has been to go to a plastic tray where peat particles or other growing medium is deposited. The plastic trays are considerably stronger than a peat pot but are not biodegradable. The prior art pots that are stronger than pots made from peat are usually made from non biodegradable materials. The pots which are the subject of the earlier patent applications discussed above are made by a process that takes a sheet of straw and/or coir and places it over a mold. A mandrel presses the straw and/or coir sheet material into the mold to give the sheet the shape and form of an individual pot. After the pots are manufactured they are typically placed one inside the other for shipment. One of the problems that was encountered from time to time with the pots occurred as the stack of pots was being separated for filling with soil and the plant. Because of the thin walls of the pot there was a risk that the side walls of the pots could tear as each pot was removed from the stack.

While it would have been preferable, due to the nature of the pots, to ship the pots individually, the cost of packaging each individual pot can be prohibitive. In addition, the shipping of individual pots is inefficient because, in the absence of stacking the pots, a manufacturer would be shipping very few pots per volume of space in a shipping container. As a result there was a need to design a new means of shipping thin walled plantable pots of the prior art and those pots which are the subject of U.S. application Ser. No. 11/646,187 and U.S. application Ser. No. 11/716,524 without damaging the pots or causing the individual pots to take up an undue amount of space during shipment from the sites of manufacture to the location of filling the pot.

Another issue with respect to many growers is biodegradability. The traditional method of generating seedlings and young plants has been to use a plastic tray having a plurality of recesses for receiving soil and seeds. When the seeds germinate and the plants reach a suitable size the individual plant is removed from the tray and placed in the ground. Even with the biodegradable planters using thin walled plantable pots described above, there are situations where after they are filled with a soil mixture and a plant, many growers may still use a plastic tray with a plurality of recesses to transport the biodegradable planters. These trays are usually petroleum based plastic and not biodegradable. A customer must remove the plant and the soil to place the plants in the ground because there is no plantable pot. Many times the soil falls off the roots exposing them to the drying effects of the air. The prior art peat type pots can be placed in these plastic trays to solve the problem of root damage in these situations but they still need the plastic trays to support the peat pots. The plastic trays, besides not being biodegradable, are becoming more expensive. Accordingly, there is a need for a tray system for transporting biodegradable pots that also protects the roots and is preferably biodegradable as well.

### OBJECT OF THE INVENTION

It is an object of the invention to provide a system for shipping pots made with straw and/or coir without damaging the pots when they are shipped one inside the other and need to be separated.

It is also an object of the invention to provide a system of shipping pots made with relatively thin side walls without damaging the pots when they are shipped one inside the other and need to be separated.

It is another object of the invention to provide a means of filling a plurality of pots at a single time and transporting the plurality of pots together.

It is still another object of the invention to provide a tray system for pots so that each individual biodegradable pots can be filled and transported as a group.

It is a further object of the invention to provide a system of transporting a plurality of filled pots.

It is still a further objection of the invention to provide a tray which carries one or more biodegradable pots that can easily release the pot from the tray for planting individually.

It is still another object of the invention to provide a biodegradable locking means to secure the pots in the tray until planting.

It is a further object of the invention to provide a handle for the tray that facilitates removal of the pots from the tray.

### BRIEF DESCRIPTION OF THE DRAWINGS

FIG. 1 is a perspective top view of the straw/coir planter useful with the present invention.

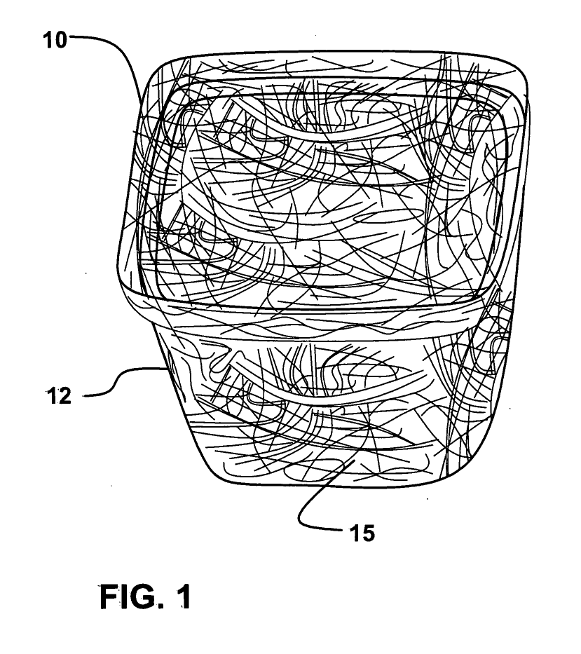

FIG. 2 is a top view of the straw/coir planter of FIG. 1.

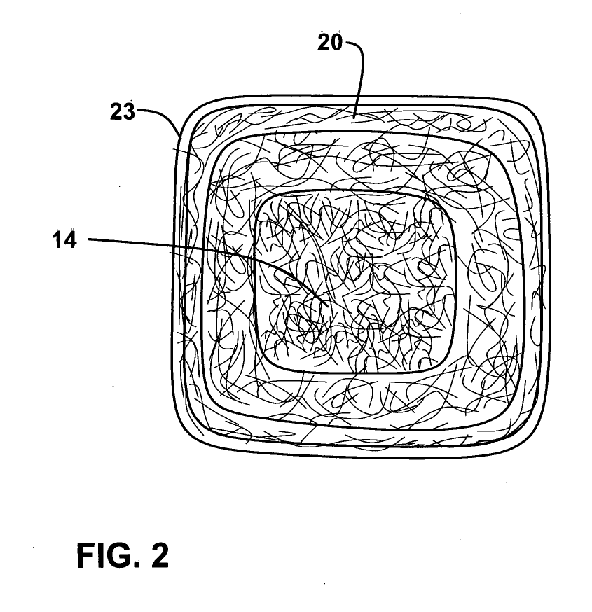

FIG. 3 is a side view of the straw/coir planter of FIG. 1.

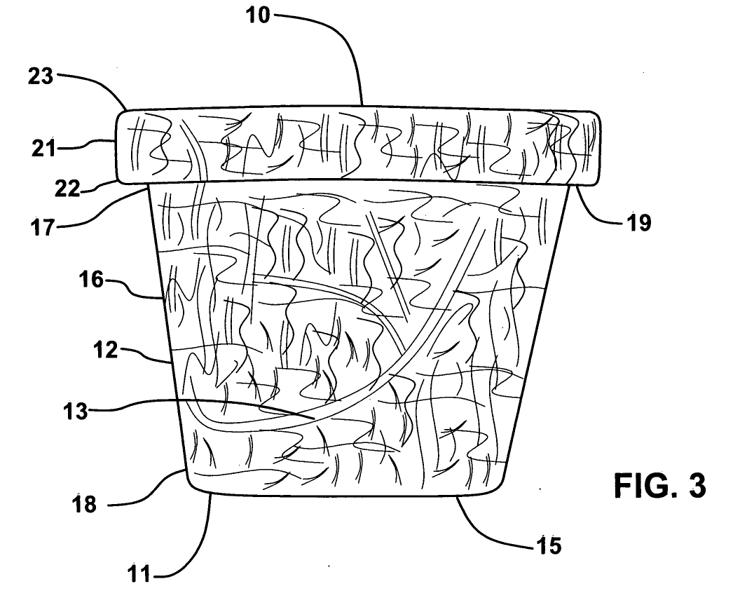

FIG. 4 is a bottom view of the straw/coir planter of FIG. 1.

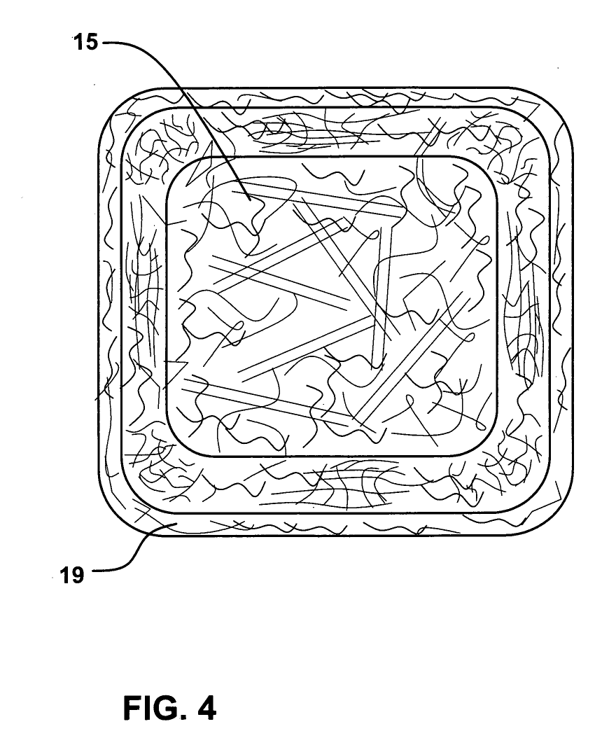

FIG. 5 is a perspective view of the tray of the present invention.

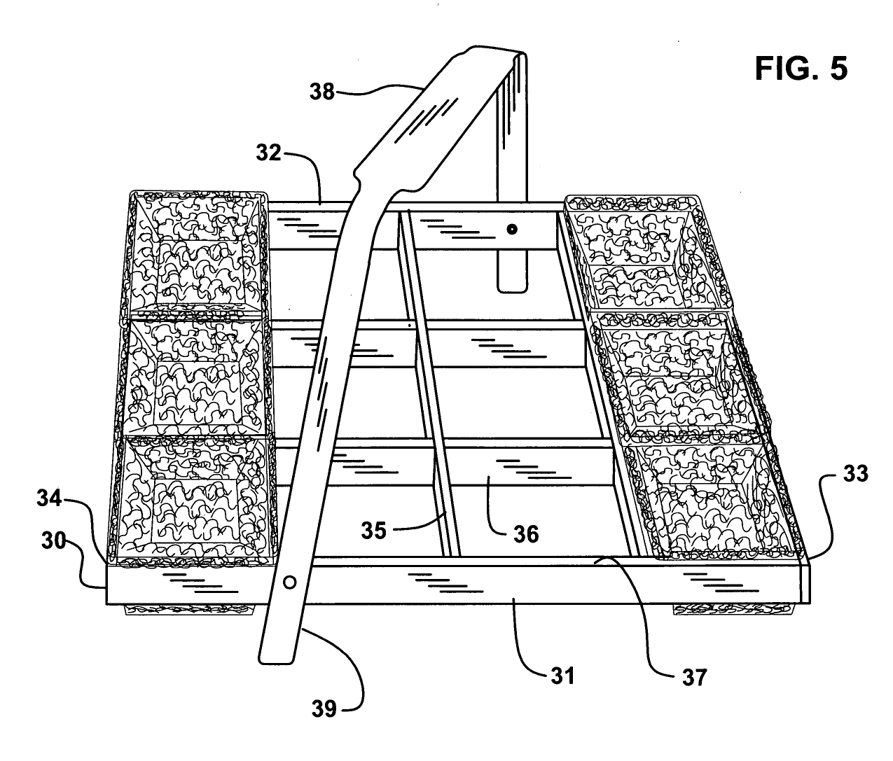

FIG. 6 is an end perspective view of the tray of FIG. 5.

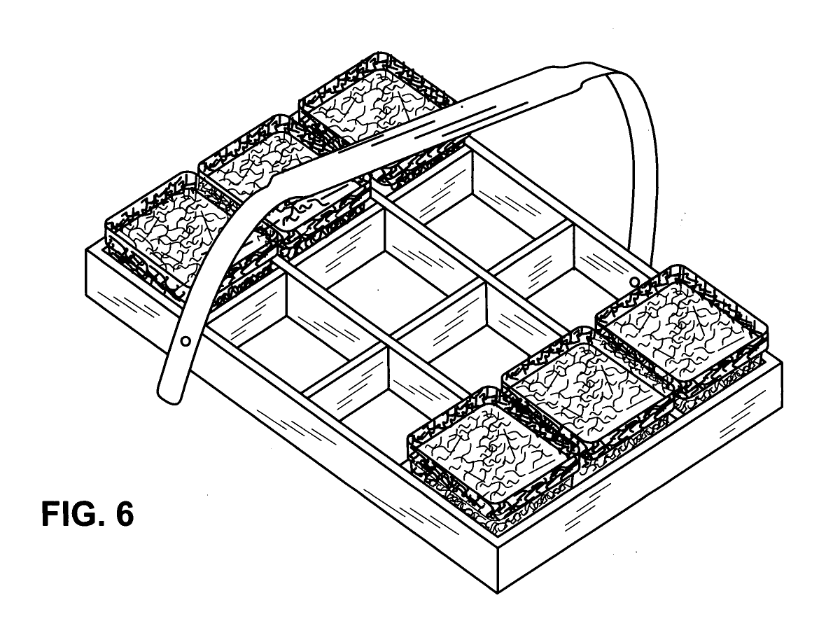

FIG. 7 is a bottom view of the tray of FIG. 5.

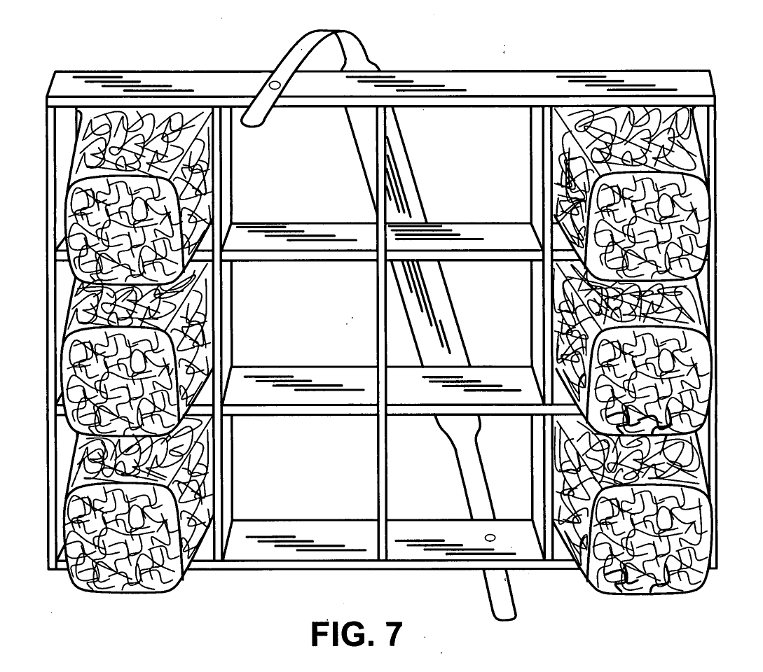

FIG. 8 is a top view of the tray of FIG. 5.

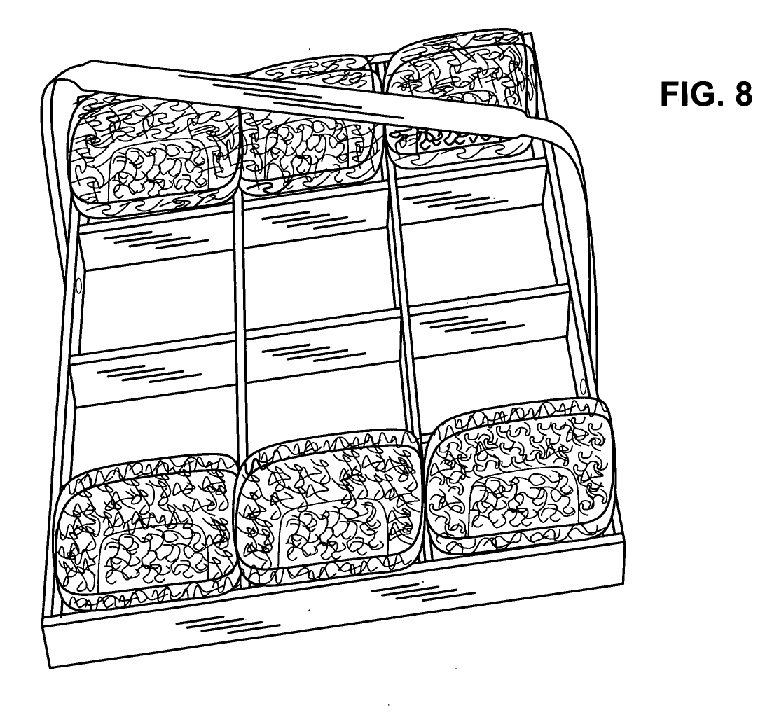

### DETAILED DESCRIPTION OF THE INVENTION

The present invention has particular applicability where a biodegradable pot or planter is desired, i.e. a pot that when planted in the ground can degrade so that it is no longer present as a unit article after a relatively short period of time, i.e., few months. The pots of the present invention are made from a biodegradable material such as straw or coir or a blend of straw and coir. In another embodiment the pots may be made with other biodegradable materials including but not limited to peat.

The first step in manufacturing the straw coir pot that may be used with the present invention is to clean the coir and straw to remove the impurities and metals that are present in the materials as these impurities may impede plant growth. One preferred coir is Cocos Nusiferra). The coconut fiber is torn from the Epicarp (husk) of the coconut. Once cleaned the straw and coir are mixed in a vat to blend the materials together. The preferred embodiment is rice straw (also known as Oriza Sataiva) but any straw may be used. Rice straw is the dried stem of the paddy. Next the straw coir mixture is fed into a hackle drum which forms into long sheets of coir and straw material. The hackle drum presses the mixture by a series of rollers which progressively squeeze the blend into thinner and thinner sheets. Once the mixture is pressed, one or both sides of the sheet is sprayed with a natural or synthetic latex which binds the materials in the blend together. It has been preferably found that only one side of the sheet needs to be sprayed with latex. Although both natural latex and synthetic latex may be used, natural latex is preferred as there are fewer impurities that may have a deleterious effect on plant growth. The sheet then passes through a dryer preferably at 120 degrees Celsius for ten minutes, to cure the rubber on the latex fiber mix. To form the planters of the present invention, the sheets are cut into required sizes, for example, in a band saw machine and the thin pressed sheet is then placed over a mold which has the shape that is desired for the resulting pot. A mandrel ram forces the sheet of straw and coir to take the shape of the mold while under high pressure usually at about 120 degrees Celsius for about 5 minutes; lastly the top edge of the pot is cut.

The planters of the present invention may be made with thinner side walls than conventional planters. This is ideal for allowing water as well as other nutrients to enter through the sidewalls. The resulting side walls also typically have a plurality of small scattered, randomly arranged orifices or voids, thus allowing water to access the surface of the fibers permitting the walls to decompose faster. These voids are typically not circular or uniform in size and shape. The base is preferably as thick as the side walls or thicker. In one embodiment, the base does not have the orifices or voids present in the side walls. The base preferably has a greater density than the side walls. In another embodiment, there are voids or orifices in the base as in the side walls. The more sturdy base of the pot allows the planter to remain structurally sound during planting, yet decompose quickly once placed in the ground. The spraying of latex onto the straw coir sheets can also add durability to the pots as it makes the walls and base of the pot more flexible, thereby less brittle.

As can be seen from the drawings, the sidewall has a plurality of fibers. These fibers are a blend of straw and coir. The sidewall of the container has a plurality of orifices in the sidewall. As can be seen these orifices or voids are randomly positioned throughout the sidewall and are of different sizes and shapes depending on how the fibers are positioned during the forming of the container. The bottom wall typically does not have the voids or orifices that are found in the sidewalls.

The composition of the present invention is a blend of 1% to 99% straw and 99% to 1% coir by weight. A preferred straw is rice straw. The preferred proportion of rice straw to coconut fiber is anywhere between 50%-99% by weight rice straw and with the remainder being coir. A more preferred proportion is between 70%-90% by weight rice straw and between 10% and 30% by weight coir. The most preferred combination is between 75%-85% by weight rice straw combine with 15%-25% by weight coir, this will lead to a pot which will decompose in a reasonable amount of time, yet retain its structure for planting, approximately 2 months.

Several embodiments were measured in order to obtain the thickness of the side wall and determine an average thickness. A Parker Hannfin-Deadal digital micrometer with a resolution of 0.001 mm was employed. Several measurements, typically at least 7 measurements of each sample embodiment were taken, using the micrometer at different points. The data was collected and the average thickness of each embodiment was calculated. An average thickness of the sample embodiments was also calculated by averaging the average thickness of each embodiment. The average thickness among several embodiments was found to be 1.7 mm. In one embodiment the average thickness of the sidewall was less than 3 mm. In another embodiment the average thickness of the sidewall was less than 2.75 mm. In still a further embodiment the average thickness of the sidewall was less than 2.5 mm. In a preferred embodiment the thickness of the sidewall was less than 2.25 mm. In a most preferred embodiment the average thickness of the sidewall is less than 1.90 mm.

Density of several embodiments was calculated using its given mass. The formula used to calculate Density was D=M/V. The volume was calculated using V=3.14(r²)(H) for the cylinder shaped embodiments. Since the radius at both ends of the cylinder are not the same the calculation was done twice, once the density was calculated using each radius measurement they two values were averaged to find an average density of the container. Density of the cube shaped pots was calculated using the same formula for density (D=M/V). The volume was found using the formula V=(L)(W)(H). Since the pot was not a perfect cube the volume was calculated twice using each base, each volume calculation was used to calculate density. The two calculated densities were then averaged together to find the average density of the pot. The rice straw coir combination once molded into the shape of the pot have an average density ranging from about 0.026 g/mm³ to about 0.0528 g/mm³. The sidewall has a lower uniform density than the base. The differences in uniform densities of the sidewall and base facilitate a speedy decomposition once planted. The low uniform density of the sidewall allows the walls to be permeated by the surrounding moisture and nutrients in the soil. This also allows the decomposition of the wall to occur quickly. The combination of an extended surface area created by the scattered orifices and the low density of the sidewall will allow the fast possible decomposition of the pot underground. The higher uniform density of the base allows for the planter to be sturdy during planting. Many types will fertilizer will also assist in the speed of the decomposition. In the process of decomposition, bacteria, fungi, molds, protozoa, actinomycetes, and other saprophytic organisms feed upon decaying organic materials initially, while in the later stages of decomposition mites, millipedes, centipedes, springtails, beetles and earthworms further breakdown and enrich the composting materials. Another advantage of the natural fiber decomposing in the soil is that it acts as compost, the nutrients from the natural fibers decomposes and fertilizes the soil surrounding the plant.

The present invention can also be used to make trays which can carry a plurality of planters of the present invention. The trays can be made of the straw coir blend and have a top surface with, a handle or other carrying means attached. The top surface has a plurality of openings for receiving pots such as pots of the present invention. Alternatively, the tray may have one or more recesses for receiving pots.

The pots 10 have a base 11 and one or more sidewalls 12 extending upwardly from the base. There is an open end to the pot opposite to the base. The open area is formed by the sidewall(s) enclosing the open area. The open area and the sidewalls form a receptacle for receiving a growing medium. In one embodiment of the present invention the pots typically have thinner side walls than their bases. In addition, the biodegradable pots of the present invention can also have plurality of openings or orifices 13 present in the sidewalls. These voids are useful because they permit moisture to contact a greater surface area of the straw or coir strands thereby facilitating degradation of the pots when they are placed in the ground. Because of the delicate sidewalls of many of the pots it has been found that there is a risk of tearing the walls from time to time when the pots are stacked for transport or for filling. As the individual pot is removed from the next pot, extreme care must be taken so that the pots are not damaged because of the high level of friction between two pots due to the materials from which they are made.

These difficulties are avoided by the system of the present invention. There is a pot having a bottom or base 11 with an inside surface 14 and an outside surface 15. The bottom or base 11 has one or more sidewalls 12 extending upwardly from the bottom. In a preferred embodiment the sidewalls flare outwardly slightly so that the cross section of the base is slightly smaller than the cross section of the opening formed by the sidewalls that is opposite the base. In a preferred embodiment the sidewall has a first section 16 extending upwardly from the base. The first sidewall section has a first end 17 and a second end 18. The second end contacts the base 11. The first end 17 is opposite the base or bottom of the container. The first section 16 preferably has a cross section smaller at the base or bottom than where the second end is located. At the first end of the first section of the sidewall there is a rim or flange 19 extending generally outwardly from the second end of the sidewall. The rim or flange 19 forms a ledge 20 on the inside surface of the pot. The flange has a first end and a second edge. The first edge contacts the first end of the first section of the sidewall. The second edge of the flange contacts a second sidewall portion 21. The second sidewall portion 21 has a first end 22 that generally contacts the second edge of the flange. The second end 23 of the second sidewall portion can form the open end of the pot. If desired additional sidewall portions and flanges may be added to the structure.

The system of the present invention includes a tray 30. The tray in its simplest form can have a first member that forms an enclosed area for receiving the pot. The first member is preferably a biodegradable member having an inner surface and an outer surface. The pot contacts a surface of the first member to hold the pot in place in the enclosed area. The tray has an outer perimeter which can be, for example, in the shape of a square or a rectangle. The embodiment shown in the Figures discloses a first strip 31 and a second strip 32 generally parallel to each other which are joined by the third and fourth strips 33 and 34 that are also generally parallel to each other and generally transverse to the first and second strips thereby forming a generally square or rectangular tray. The strips are preferably made from an inexpensive rapidly growing natural material so that the tray is biodegradable as well. Extending from the first strip to the second strip are one or more additional center strips 36 that form generally square openings with the third and fourth strips. The center strips are parallel to the first and second strips. There may also be one or more additional transverse center strips 35 that are parallel to the third and fourth strips, depending on how large a tray is desired. For example a tray with two center strips parallel to the first and second strips and two transverse center strips parallel to the third and fourth strips forms a tray with nine openings adding an additional center strip creates a further opening in the tray. The center strips preferably have a first end and a second end and a flat side surface on the front and rear of the strip. There is also a top surface and a bottom surface on each of the strips. In a preferred embodiment the first and the second ends of the center strip are secured to the inside surface of opposite perimeter strips. A nail or tack can be inserted through the outer surface of the perimeter strip and into the end of the center strip. The center strips can have a notch for receiving the notch of a cross center strip. The notches permit the center strip to interlock.

The openings formed by the strips receive the base of the pots. The top surface of the strips 37 form a support for the outwardly extending flange on the sidewalls of the pots. This arrangement permits the pots to be stacked such that the base of one pot goes into the opening of a second pot without the sidewalls being wedged together making it difficult for the pots to become separated. There may be a handle 38 that is attached to the outside strip and extends over the opposite outside strip. The handle may be made from a biodegradable material such as bamboo. The handle may also be provided with a leg portion 39 that raises the tray above the surface on which the tray is placed. This prevents the tray from prematurely falling down when the pots are placed in the tray. When the pots are to be removed the handle can be lowered. As the handle is lowered the tray is lowered thereby releasing the pots for removal. In another embodiment there may be one or more rods that generally have a length above the distance from one sidewall to the opposite sidewall. The rods may have a point at the end. The pointed end of the rod goes into a portion of the biodegradable pot that extends below the tray this rod passes through all of the pots in a row. The rod prevents the tray from dropping down when the handle is not present or where the handle is not in a raised position.

I claim:

1. A system for transporting a biodegradable planter comprising a tray for carrying a biodegradable planter said tray comprising of a first biodegradable member said biodegradable member forming an orifice surrounded by said biodegradable member for receiving a biodegradable planter said biodegradable member having a cross section extending from one side of said biodegradable member to an opposite side of said biodegradable member, said biodegradable planter having a least one side wall and a base, said sidewall forming a receptacle for receiving a plant growing medium, said planter having a first cross section extending from one exterior side of said sidewall to an opposite exterior side of said sidewall and a second cross section extending from one exterior side of said sidewall to an opposite exterior side of said sidewall said first cross section being at a location along said sidewall different from the location of said second cross section and wherein said second cross section is smaller than said first cross section, and wherein said first cross section of said planter contacts at least a portion of surface of said biodegradable member causing said biodegradable planter to be retained in said tray.

2. The system according to claim 1 wherein said tray has more than one biodegradable member forming orifices for said planters.

3. The system according to claim 1 wherein said tray has first and second biodegradable members that are generally parallel to each other and third and fourth biodegradable members, said third and fourth biodegradable members being generally parallel to each other and at generally right angles to said first and second members.

4. The system according to claim 1 wherein said biodegradable member has a biodegradable handle secured to a first portion of an outer surface of said biodegradable member, said handle extending from said outer surface of said biodegradable member to a second outer portion of said outer surface of said biodegradable member, said first portion being opposite said second portion of said biodegradable member.

5. The system according to claim 4 wherein said handle is rotatable.

6. The system according to claim 4 wherein said handle has a first end and a second end said first end and said second end extending below a bottom surface of said biodegradable member when said handle is in a raised position and not extending below said bottom surface of said biodegradable member when said handle is in a lowered position.

7. The system according to claim 4 wherein said handle is in a raised position said handle is generally at a 90° angle to said biodegradable member.

8. The system according to claim 6 when said handle is in a lowered position said handle is generally parallel to at least a portion of the exterior surface of said biodegradable member.

9. The system according to claim 8 wherein there is a pin extending from one exterior surface of said planter through an opposite exterior surface of said planter said pin contacting an underside of said first biodegradable member to prevent said planter from being removed from said tray when said tray is positioned on a surface.

10. The system for transporting a biodegradable planter comprising a tray for carrying a biodegradable planter said tray comprising a first plurality of generally parallel members and a second plurality of generally parallel members said first group being generally perpendicular to said second group said first and second groups forming a plurality of enclosed areas for receiving biodegradable planters said enclosed areas formed by said members being open at each end, said biodegradable planter having at least one side wall, and a base extending from said sidewall, said sidewall forming a receptacle for receiving a plant growing medium, said planter having a first cross section extending from one exterior side of said sidewall and a second cross section extending from one exterior side of said sidewall to an opposite exterior side of said sidewall, said first cross section being at a location along said sidewall different from the location of said second cross section and wherein said second cross section is smaller than said first cross section, and wherein said first cross section of said planter contacts at least a portion of surface of said biodegradable member causing said biodegradable planter to be retained in said tray.

11. The system according to claim 10 wherein said tray has more than one planter.

12. The system according to claim 10 wherein said tray has a biodegradable handle secured to a first portion of an outer surface of said tray, said handle extending from said outer surface of tray to a second outer portion of said outer surface of said tray, said first portion being opposite said second portion of said tray.

13. The system according to claim 12 wherein said handle is rotatable.

14. The system according to claim 12 wherein said handle has a first end and a second end said first end and said second end extending below a bottom surface of said tray when said handle is in a raised position and not extending below said bottom surface of said tray when said handle is in a lowered position.

15. The system according to claim 14 when said handle is in a raised position said handle is generally at a 90° angle to said tray.

16. The system according to claim 15 wherein when said handle is in a lowered position said handle is generally parallel to at least a portion of the exterior surface of said tray.

17. The system according to claim 16 wherein there is a pin extending from one exterior surface of said planter through an opposite exterior surface of said planter said pin contacting an underside of said tray to prevent said planter from being removed from said tray when said tray is positioned on a surface.

18. The system according to claim 17 wherein said planter is made of straw or coir or both.

19. The system according to claim 18 wherein said planter has later on one surface of said straw or coir.

20. The system according to claim 17 wherein said planter comprises peat.
